(19) United States
(12) Patent Application Publication
(10) Pub. No.: US 2013/0329631 A1
(43) Pub. Date: Dec. 12, 2013

(54) METHODS AND APPARATUS FOR ENHANCED TRANSMIT POWER CONTROL

(71) Applicants: Muhammad Adeel Alam, San Jose, CA (US); Giri Prassad Deivasigamani, Cupertino, CA (US); Gaurav Nukala, Cupertino, CA (US)

(72) Inventors: Muhammad Adeel Alam, San Jose, CA (US); Giri Prassad Deivasigamani, Cupertino, CA (US); Gaurav Nukala, Cupertino, CA (US)

(21) Appl. No.: 13/490,332

(22) Filed: Jun. 6, 2012

(51) Int. Cl. H04W 52/04

(52) U.S. Cl. 370/328

(57) ABSTRACT

Methods and apparatus for improved power control in communications (such as connection establishment) in a wireless network. In one embodiment, a data-based, iterative approach is used to select an appropriate transmission power level during the establishment of a wireless connection. An assessment of the quality of the channel between a connecting device and target device is made, based on a received reference signal from the target device. The assessment is used to select an initial power level for a random access request. In the case a response is not received, a subsequent assessment of the channel quality is made. If the quality of the channel has changed, then a second power level for a second random access request is selected. This approach allows the connecting device to adapt to changing conditions related to the channel quality, and adjust its transmission power level accordingly.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

1. Field of Invention

The present invention relates generally to the field of mobile technology and wireless communications. More particularly, in one exemplary aspect, the present invention is directed to adjusting power levels in wireless transmissions, such as for example with respect to transmission power levels during while establishing a wireless connection.

2. Description of Related Technology

Poor connectivity has a direct effect on the quality of service perceived by wireless customers. For example, poor connectivity can lead to dropped calls, and/or cause instability in applications that rely on streaming data. Thus, connection quality for communications links between wireless devices is an important facet in wireless communications.

In the exemplary context of wireless cellular technology, a mobile device performs a “handover” by switching a communication link from one base station to another base station. Handovers are classified as “soft” or “hard”. Soft handovers (commonly used in Code Division Multiple Access (CDMA) technologies) establish a connection to a target base station (BS) before breaking the connection with its current base station (soft handovers are colloquially classified as “make before break”). For a short period of time, the UE maintains communications with both the target BS and its current BS. Thus, if connectivity to either BS fails, the UE can safely continue operation on the remaining BS without service interruption. In contrast, in hard handovers, the UE drops its connection to its current BS before attempting to establish a connection to another target BS (hard handovers are colloquially classified as “break before make”). Hard handovers were used in earlier cellular technologies due to their simpler implementation. More recently, Long Term Evolution (LTE) standards have renewed interest in hard handovers for data-only operation, largely because hard handovers have lower overall network overhead as compared to soft handovers.

During initial network accesses, the mobile device sets an initial transmit power. In Time Division Multiple Access (TDMA) and Frequency Division Multiple Access (FDMA) technologies, transmit power is largely an electrical power consumption consideration. While higher transmit power is undesirable in that it consumes more electrical power from, e.g., a mobile device battery, transmitting at low power may result in a failure to connect (and subsequent retry attempts). Code Division Multiple Access (CDMA) technologies introduced much tighter power requirements for mobile devices, because each mobile device interferes to varying degrees with its peer devices. Similarly, due to reception processing limitations in Orthogonal Frequency Division Multiple Access (OFDMA) technologies, OFDMA also implements very tight power control requirements.

Current schemes for power “ramping” (i.e. increasing transmit power levels) while establishing a communication link between wireless devices utilize “fixed” power ramping. Fixed power ramping does not fully account for the rapidly changing conditions that exist in high mobility applications. Specifically, in certain scenarios, high mobility applications experience rapid fluctuations and dynamic ranges of the radio environment. Even in relatively stable radio environments (e.g., low mobility use cases), fixed methods may be inadequate for transient interference events. Still further, fixed power ramping can unduly extend the period required to establish a wireless connection even in optimal conditions; longer ramping time may dramatically affect battery performance.

Thus, improved solutions are needed for managing initial network accesses in current wireless technologies that consider both device considerations (e.g., power consumption, likelihood of success, etc.) as well as network considerations (e.g., interference, etc.). More generally, improved methods and apparatus are needed for connection establishment within dynamically changing radio environments.

### SUMMARY OF THE INVENTION

The present invention satisfies the aforementioned needs by providing, inter alia, improved apparatus and methods for power ramping while establishing a wireless connection.

In a first aspect, a method for establishing a connection to a target apparatus with an initiating device is disclosed. In one embodiment, the method includes: determining a parameter at a first time, where the determined parameter is related to a power associated with signal transmitted by the target apparatus; and transmitting an access attempt at a first power level, the first power level based at least in part on the determined parameter. When a response to the access attempt is not received, the parameter is updated at a second time; and a second access attempt transmitted at a second power level, the second power level based at least in part on the updated parameter.

In one variant, the method further includes setting the second power level at the first power level increased by a fixed increment when the updated parameter is not substantially different from the parameter determined at the first time.

In another variant, the method further includes, when the updated parameter is not substantially different from the parameter deter mined at the first time, setting the second power level equal to the first power level plus a fixed increment; and otherwise dynamically determining the second power level based on the updated parameter.

In one particular implementation, the initiating device is an LTE-enabled UE, the signal transmitted by the target is a reference signal (RS), and the access attempt is a random access channel (RACH) related communication.

In a second aspect of the invention, a mobile device is disclosed. In one embodiment, the device is configured to establish a connection to a target apparatus in a wireless network, and includes: a wireless transceiver, the transceiver configured to receive a reference signal; transmit one or more request signals at one or more respective power levels, and receive a response to the transmitted one or more request signals; a processor; and a non-transitory computer-readable storage comprising a plurality of instructions. In one variant, the instructions are configured to, when executed by the processor, monitor a value related to a signal strength of the reference signal at one or more times, and determine the respective power levels for the one or more request signals, at least one of the respective power levels based at least in part on the monitored value.

In another embodiment, the mobile device is configured to selectively adjust transmit power based at least on its radio environment, and includes: a processor; a radio transceiver in signal communication with the processor; and computerized logic in communication with the transceiver. In one variant, the logic is configured to: utilize the transceiver to sense at least one aspect of the radio environment; select a transmit power for a transmission to be sent to a target device, the selection being based at least in part on the sensed at least one aspect; cause the transmission to be transmitted from the transceiver; monitor for an indication of receipt of the transmission by the target device; and based on an absence of the indication, determine a transmit power for a second transmission. The determined transmit power for the second transmission is selected to maximize a likelihood that the second transmission will be received by the target device.

In a third aspect of the invention, a method for establishing a connection to a target apparatus with an initiating device is disclosed. In one embodiment, the method is implemented in a wireless network, and includes: determining a first parameter related to a received signal power associated with a transmission of the target apparatus; determining a second parameter related to a likelihood of success for the connection; and transmitting an access attempt at a first power level, the first power level based at least in part on the first and second parameters.

In a fourth aspect of the invention, a network entity is disclosed.

In a fifth aspect of the invention, a wireless system is disclosed. In one embodiment, the system comprises at least one base station and a plurality of user mobile devices, the latter being configured to intelligently adjust their transmit power for at least certain transmissions so as to (i) reduce connection latency, and (ii) mitigate potential interference with others of the mobile devices.

In a sixth aspect of the invention, a computer readable apparatus is disclosed. In one embodiment, the apparatus includes a storage medium with at least one program configured to, when executed, implement intelligent transmit power selection logic for a mobile wireless device.

In a seventh aspect of the invention, a method of optimizing user experience on a mobile wireless device is disclosed. In one embodiment, the method includes selectively implementing a transmit power scheme or schemes which optimize battery longevity and user data processing continuity while mitigating potential for interference with other mobile devices due to, inter alia, excessive transmit power.

Other features and advantages of the present invention will immediately be recognized by persons of ordinary skill in the art with reference to the attached drawings and detailed description of exemplary embodiments as given below.

### BRIEF DESCRIPTION OF THE DRAWINGS

FIG. 1 is functional block diagram illustrating one exemplary Long Term Evolution (LTE) cellular network useful with various aspects of the present invention.

FIG. 2 is a logical flow diagram depicting one embodiment of a generalized method for transmission power level selection during wireless connection establishment according to the invention.

FIG. 2A is a logical flow diagram depicting an exemplary scheme for improved transmission power level selection during the establishment of a wireless connection according to the invention.

FIG. 3 is a functional block diagram of one embodiment of a mobile device configured according to various aspects of the present invention.

FIG. 4 is a functional block diagram of one embodiment of a base station device configured according to various aspects of the present invention.

FIG. 5 is a ladder diagram detailing operation of one exemplary embodiment of the present invention.

All Figures © Copyright 2012 Apple Inc. All rights reserved.

### DETAILED DESCRIPTION OF THE INVENTION

Reference is now made to the drawings, wherein like numerals refer to like parts throughout.

### Overview

Various aspects of the present invention are directed to, inter cilia, selecting an appropriate transmission power level during e.g., wireless connection establishment. In one embodiment, a data-based, iterative approach is used in this selection. Specifically, in one implementation, an assessment of the quality of the channel between a connecting device and target device is made, based on a received reference signal (or pilot signal) from the target device. The assessment is used to select an initial power level for subsequent ramping attempts. Subsequent assessments of the channel quality may additionally consider if the quality of the channel has changed significantly.

More generally, various embodiments of the present invention are directed to intelligent management of transmission power based on dynamically determined radio channel assessment (as opposed to linear or fixed increments to an initial transmission power level).

For example, a user equipment (UE) in a car may experience very fast changes in channel quality. Prior art UE transmit power ramping techniques are based on a fixed scheme that is unlikely to quickly establish a connection. In contrast, the exemplary UE configured according to the present invention can alter its transmit power ramping adaptively to respond to actual channel conditions. This ramping procedure has a much higher probability of success, which results in better connection speeds and improved reception capabilities.

Various implementations of the present invention truncate the number of random access request retries necessary when establishing a connection between wireless devices. For example, rather than ramping from a low transmit power to a higher transmit power, a UE “skips” unnecessary (and likely to fail) low-power transmissions, and immediately transmits at a transmit power level that has a high likelihood of success. Truncating random access request attempts may improve battery performance (fewer transmissions results in less battery usage) and faster connection initiation (less steps results in less time used to establish the connection). However, it is appreciated that if the UE transmits at the maximum allowed power on the first attempt, the system will be limited in the number of UE that may be used in proximity to each other. Specifically, high power transmissions can increase interference with other devices. Thus, various embodiments of the present invention further address this issue (e.g., through realization of an optimization and/or network cost/benefit analysis).

### DETAILED DESCRIPTION OF EXEMPLARY EMBODIMENTS

Exemplary embodiments of the present invention are now described in detail. While these embodiments are primarily discussed in the context of cellular communications technologies, the present invention is in no way so limited. The present invention may be implemented to increase efficiency and reduce interference in literally any system in which a wireless remote connection must be established between devices.

### Existing Network Technologies—

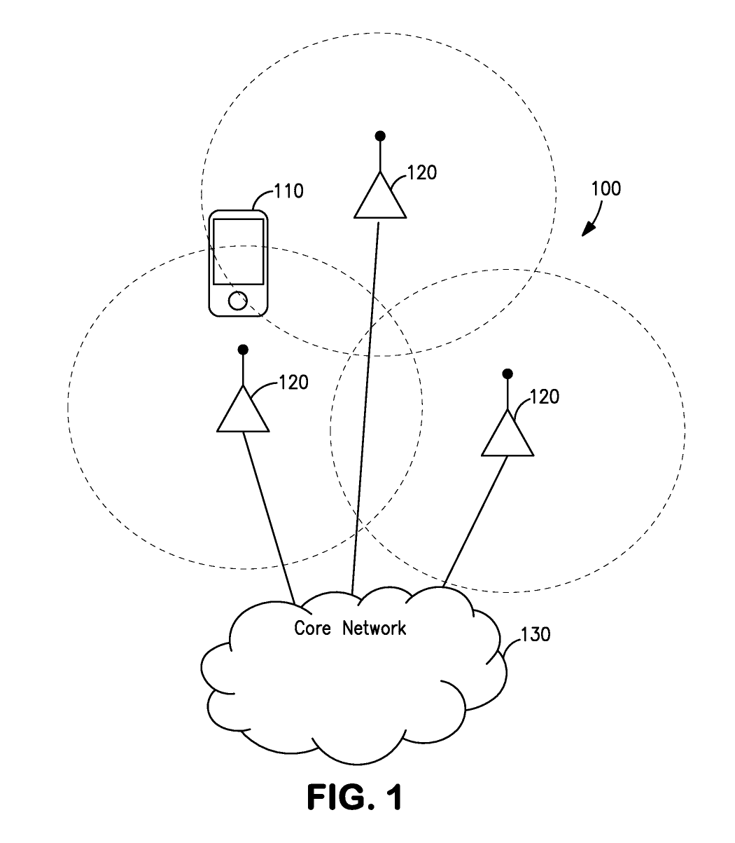

FIG. 1 illustrates one exemplary Long Term Evolution (LTE) cellular network 100, with user equipment (UEs) 110, operating within the coverage of the Radio Access Network (RAN) provided by a number of base stations (BSs) 120. The LTE base stations are commonly referred to as “Evolved NodeBs” (eNBs). The Radio Access Network (RAN) is the collective body of eNBs along with interfaces to other network elements such as mobility management entities (MME) and serving gateways (S-GW). The user interfaces to the RAN via the UE, which in many typical usage cases is a cellular phone. However, as used herein, the terms “UE”, “client device”, and “user device” may include, but are not limited to, cellular telephones, smartphones (such as for example an iPhone™ manufactured by the Assignee hereof), personal computers (PCs) and minicomputers, whether desktop, laptop, or otherwise, as well as mobile devices such as handheld computers, tablets, PDAs, personal media devices (PMDs), or any combinations of the foregoing.

Each of the eNBs 120 are directly coupled to the Core Network 130 e.g., via broadband access. Additionally, in some networks the eNBs may coordinate with one another, via secondary access. The Core Network provides both routing and service capabilities. For example, a first UE connected to a first eNB can communicate with a second UE connected to a second eNB, via routing through the Core Network. Similarly, a UE can access other types of services e.g., the Internet, via the Core Network.

While the following discussion is made in relation to the exemplary LTE network of FIG. 1, it is further appreciated that, in light of this disclosure, the present invention may be applied to other wireless technologies including, inter alia, cellular technologies such as 3G and 4G technologies (e.g. GSM, UMTS, CDMA, CDMA2000, WCDMA, EV-DO, 3GPP standards, EDGE, GPRS, HSPA, HSPA+, HSPDA, and/or HSPUA, etc.), or wireless local/wide area network technologies, such as Wi-Fi (IEEE 802.11a/b/g/n/s/v), WiMAX (IEEE 802.16), or PAN (802.15).

Referring back to the LTE network of FIG. 1, a UE initiates access to the eNB via a random access request on a random access channel (RACH). RACH accesses are common during e.g., handover procedures, mobile initiated data transactions, etc. Specifically, the UE initiates RACH operation whenever it attempts to transition from idle mode to connected mode operation with the eNB.

As a brief aside, RACH operation is based on an initial assessment of the quality of the radio channel between the UE and the target BS. For example, common examples of measured radio channel quality may involve e.g., signal strength measurements, bit-error rate assessments of a broadcast control channel, etc. The UE selects an initial power at which to transmit a request for access to the target BS based on the radio channel quality. If the BS successfully receives the RACH attempt, the BS will respond within a set time period. If the BS does not receive the RACH attempt, the UE will re-attempt the RACH access with an incrementally higher transmit power. By ratcheting up transmit power gradually, the UE ostensibly transmits at or near the minimum power necessary for the BS to respond; higher transmit power can increase interference effects on nearby UEs.

Once the communication link has been established between the UE and the target BS, the transmission power level used by the UE is controlled in a closed-loop fashion with the target BS. In particular, the BS will inform the UE if it is transmitting at too high (or too low) of power, the UE will adjust its transmission power accordingly. Closed-loop power control intelligently balances spectral resource utilization with performance; unfortunately, the initial RACH accesses must be performed without the BS feedback mechanism, since there is no communication link between the UE and the BS existing at that point.

### Methods—

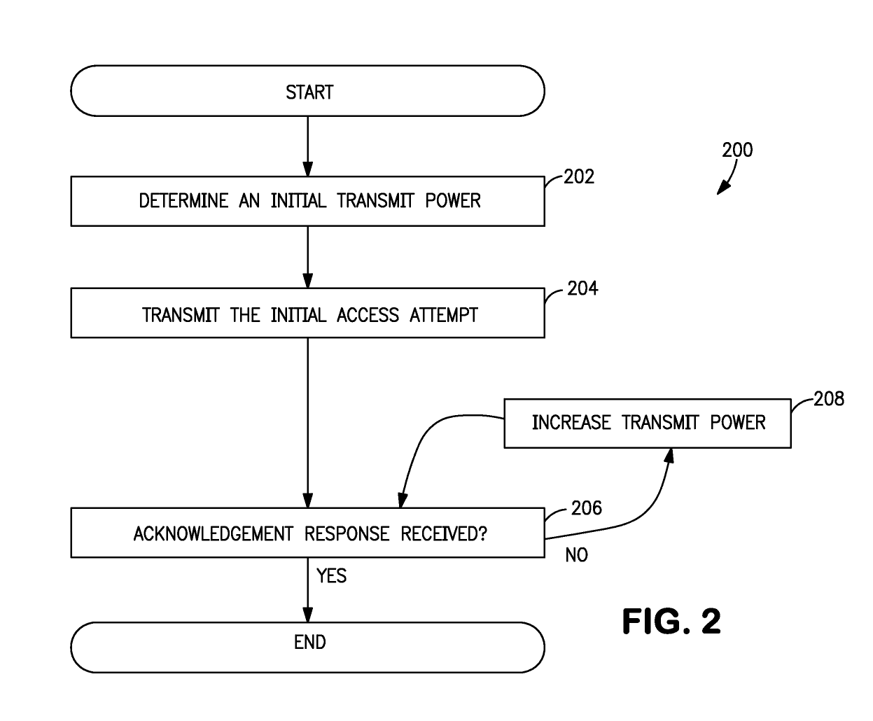

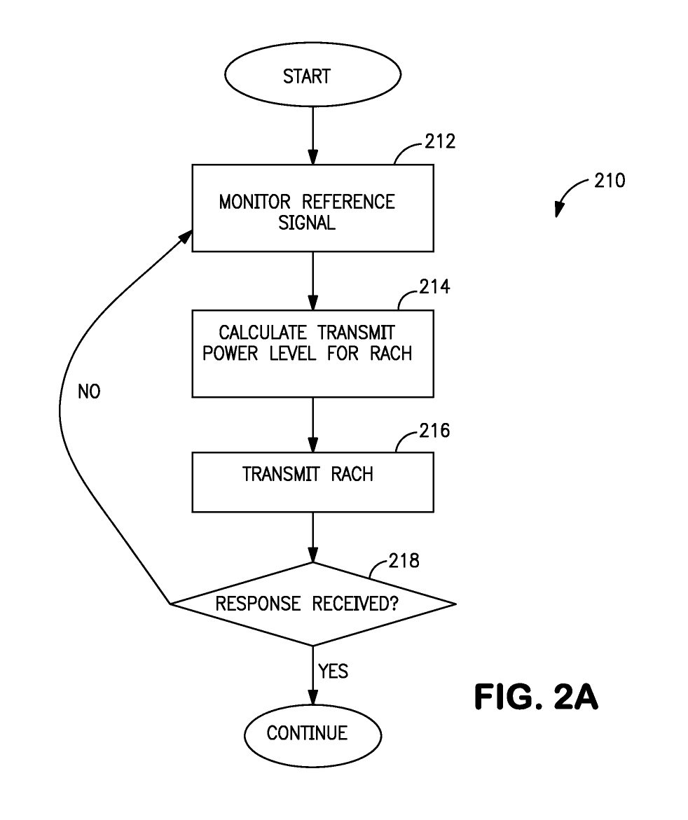

Referring now to FIG. 2, one embodiment of a generalized method 200 for improved power ramping consistent with the present invention is disclosed. In the following description, an initiator device attempts to establish a connection with a target device. While the following example is provided with respect to a wireless client device and a serving entity (such as a cellular device and a base station, respectively), it is appreciated that the following procedures are widely applicable to other topologies including e.g., peer-to-peer, host/slave, etc. Moreover, while the following examples are provided with a client device being the initiator device, it is appreciated that other topologies may reverse these roles i.e., the initiator device may be the serving entity, etc. At step 202 of the method 200, the initiator device determines an initial transmit power for an access attempt to the target device. In one embodiment, the initial access attempt is a random access attempt (e.g., not previously scheduled and/or randomly initiated). In one exemplary implementation, a user equipment (UE) initiates a Random Access Channel (RACH) access to attempt connection establishment (e.g., to transact voice and/or data) with an evolved Node B (eNB) of a Long Term Evolution (LTE) cellular network. In other embodiments, the initial access attempt may be based on a predetermined or even dynamically determined schedule. Still other initial access attempts may be actively or passively triggered by the target device; for example, in certain applications, the initiator device may receive a beacon, message, or other event instigated by the target, and responsively initiate access to the target device.

Initial transmit power may be determined according to a wide variety of schemes. In one embodiment, the initial transmit power may be determined on the basis of an initial determination of radio channel quality. For example, a UE can determine the radio channel environment from one or more reference signals (RS) broadcast by the eNB. Each RS is generated according to a fixed pattern. The UE can determine an estimate of the channel conditions based on the degree and amount of distortion of the received RS (e.g., attenuation, distortion, etc.). By collecting channel conditions for each of the RS over the entire radio channel, the UE can interpolate the channel condition for the entire radio channel. Due to the radio channel symmetry properties (i.e., between measurement intervals, the radio channel is the same, or substantially the same, in uplink and downlink directions), the UE can determine an appropriate initial transmit power based on the channel conditions of the received signals.

Other schemes for initial transmit power determination may be based on e.g., an initial value provided by the target device, a measured received signal strength (such as RSSI or the like), a measured noise level, a predetermined fixed value, etc.

At step 204 of the method 200, the initiator device transmits the initial access attempt. In one exemplary embodiment, if the target device receives the initial access request, the target device responds with an acknowledgement.

In some variants, the initial access request may include identifying information for the initiator device. In other variants, the initial access request includes an identifier for the access itself (such that the access can be distinguished from other accesses). The identifier can be unique, the identifier may likely be unique (i.e., uniqueness is not guaranteed, but highly likely), or even non-unique (e.g., such as an identifier that is periodically re-used).

In one embodiment of the method 200, the initial access request is performed on a contention-capable channel (i.e., other devices may attempt an access at the same time, leading to a contention error). In other embodiments, the initial access request is performed on a contention-less or even dedicated channel (i.e., each device is reserved a specific access resource which is never under contention). For contention-capable channels, the initial access request may be corrupted by other overlapping requests, thus contention-capable channels generally require some form of error detection (e.g., a Cyclic Redundancy Check (CRC), etc.). For contention-less channels, the initial access request may experience corruption based on radio conditions, such as fading, interference from other emitters, etc.

The acknowledgment response may include, for example, an indication of success/failure, reasons for failure (e.g., malformed or corrupted message, network unavailability, excessive network congestion, access contention or collision, etc.), retry information (e.g., back-off information, etc.), authentication and authorization information, connection establishment information or message, resource allocation information, etc.

At step 206 of the method 200, if the initiator device receives the acknowledgement response, then the initiator device and target device can commence connection establishment procedures. Generally, while connection establishment procedures include e.g., authentication, authorization, resource allocation, etc., it will be appreciated that other types of activities pursuant to connection establishment may be performed at this stage. For instance, responsive to receiving the initial access, the target device responds with a connection response. In some embodiments, the target device may respond provided other conditions are met (e.g., a network may additionally consider factors such as whether a CRC passed, the presence or absence of network congestion, total processing burden, the identity of the originator of the request, etc.). In the exemplary implementation, the target device connection response explicitly or implicitly indicates that: (i) the initial access was received, (ii) the initial access was properly decoded, and (iii) the network is capable of servicing the initial access. For example, in certain variants, the target device affirmatively indicates that the foregoing criteria have been met. Alternatively, the target device may be configured such that it will not respond unless it has received, correctly decoded, and is capable of servicing the initial access (i.e., met the three criteria (i)-(iii)). In yet other alternate variants, the target device may respond for any subset of the foregoing, but may additionally include information such as: information regarding decode errors, instructions to retry, instructions to wait before retrying, instructions to wait until prompted before retrying, instructions to stop further attempts, instructions as to alternative resources to utilize, etc. In some cases, a connection response may additionally provide information useful for the initiator device to further adjust initial access operation (e.g., increase transmit power, decrease transmit power, etc.).

In still other alternate embodiments, the target device must always respond if a message has been received. In such variants, the target device can either provide a positive or negative connection response. For example, a positive connection response (which may be as simple as a single bit set to “1” or “0” for instance) indicates the target device can service the initial access request. In contrast, a negative connection response indicates the target device cannot service the initial access request. In some variants, the initiator device may back-off for e.g., fixed, dynamically determined, or random time or other interval). In other variants, the initiator device may back-off until notified otherwise (e.g., with paging indicator, etc.).

It is also contemplated that in certain implementations of the method, the initiator device may speculatively commence connection establishment procedures before it has received the acknowledgement from the target (to the extent that it is able, such as performing steps of the connection procedure which do not require participation by the target), so as to minimize connection setup time in the event that an acknowledgement is in fact received.

If no acknowledgment response is received from the target, then the initial transmit power is assumed to be insufficient, and the initiator device will responsively increase (“ramp”) power (step 208). In one exemplary embodiment, the initiator device adjusts one or more subsequent transmit powers according to one or more dynamically determined adjustment criteria, and re-attempts access.

In certain implementations, the initiator device is configured to measure signal strength of one or more signals in order to determine and/or monitor the current radio channel conditions. In one such implementation, the signal strength of the monitored signal is measured over a time interval (e.g., as an average, accumulation, etc.). In other approaches, the signal strength of the signal is characterized according to a maximum or peak strength. The signal strength can be periodically or intermittently measured (e.g., based on interspersed RS, such as those employed within LTE networks); alternately, the signal strength can be continuously measured (e.g., based on a continuous broadcast of a so-called pilot signal, such as those employed within CDMA 1X networks). Common metrics for signal strength that can be used consistent with the exemplary embodiments of the present invention include for example: Received Signal Strength Index (RSSI), Signal to Noise Ratio (SNR), Signal to Interference plus Noise Ratio (SINR), Reference Signal Received Power (RSRP), etc.

As an illustration, consider a UE which bases an initial transmit power for a RACH on a measured RSRP from the base station (e.g., eNB). If the eNB is unresponsive to the RACH, then the UE determines the current RSRP which may have changed in the interim, and adjusts its power ramping to compensate for any changes in RSRP. For example, a rapidly changing radio environment may exhibit a significantly lower RSRP than the initially measured RSRP; to correct for the sudden drop in RSRP, the UE can boost its transmit power by a corresponding adjustment for subsequent access attempts (and vice versa).

In other embodiments, the initiator device measures the quality (or change in quality) of one or more signals. The quality of the monitored signal can be based for example on a Bit Error Rate (BER), Block Error Rate (BLER), or Packet Error Rate (PER). In some variants, the BER is specific to a subset of the signals e.g., Reference Signal Received Quality (RSRQ), etc. For example, a lower RSRQ will result in a corresponding boost in transmit power for subsequent access attempts.

In still other embodiments, the initiator device measures a “time of flight” for the monitored signal. Time of flight colloquially describes the amount of time (and by relation, distance) necessary for the radio frequency signal to propagate from the transmitter to the receiver. Traditionally, time of flight is measured and tracked with timing advance (TA) signaling, etc. TA values are proportional to the total distance, thus a large TA value ostensibly indicates a larger path length between transceivers, whereas a short TA value indicates a shorter distance. For instance, a much higher TA will result in a corresponding boost in transmit power to compensate for the farther distance between transmitter and receiver.

Moreover, while the foregoing embodiments are described in terms of a single parameter, it is appreciated that multiple parameters may be used, whether concurrently or selectively at different times or in different situations. For example, a device may measure signal strength, signal quality, and/or time of flight. It is additionally appreciated that parameters may be in considered in light of differential, proportional, integral, absolute, or a combination of such behaviors. Those of ordinary skill in the related arts will, given the present disclosure, readily recognize the benefits of proportional integral and derivative (PID) feedback control loops for signal conditioning and signal processing in conjunction with the foregoing embodiments.

Generally, it is appreciated by those of ordinary skill in the related arts that various considerations may be used in addition to the rapid fluctuations and dynamic ranges of the radio environment. For instance, within the context of LTE networks, each RACH attempt consumes a significant amount of power, thus excessive RACH attempts are undesirable from the UE's perspective. Moreover, multiple RACH attempts contribute to longer data latencies. High powered RACH attempts are more likely to succeed, but unfortunately can also pollute the spectrum for other users. Thus, excessively high powered RACH attempts are undesirable from a network standpoint.

Accordingly, various embodiments of the present invention may further “intelligently” optimize transmit power according to various operational factors including, without limitation: historical likelihood of success at a power level, power consumption, number of iteration attempts, overall network congestion, latency, etc. For example, in one implementation, a UE can increase the transmit power of subsequent transmissions to increase the likelihood of successful connection, or decrease its transmit power for subsequent transmissions based on radio environment considerations e.g., spectral usage of other devices, etc.

Referring now to FIG. 2A, one exemplary implementation of the generalized method 200 of FIG. 2 is shown and described.

As an initial step 212 of the method 210 of FIG. 2A, a user equipment (UE) monitors one or more reference signals (RS) which are broadcast by evolved Node Bs (eNBs). The monitored RS provides information to the UE regarding the radio conditions associated with the eNB. For instance, a Long Term Evolution (LTE) user equipment (UE) attempting to establish a connection with a evolved Node B (eNB) monitors a Reference Signal (RS) received from the eNB and determines the Reference Signal Received Power (RSRP).

At step 214, the UE calculates an appropriate power level at which to transmit a RACH attempt to the eNB. For example, in one such approach, the initial transmit power is based on the measured RSRP. The calculation may incorporate other data as well, such as for example power management considerations, historical likelihood of success, network congestion or other operational considerations, etc. For example, the UE can adjust its transmit power so as to improve the probability of success based on historical performance within certain network conditions, which results in better connection speeds and improved reception capabilities. In another example, the UE can truncate the number of retries necessary when establishing a connection to the cellular network. Rather than ramping from a low transmit power to a higher transmit power, a UE may “skip” underpowered transmissions (which are likely to fail), and immediately transmit at a transmit power level commensurate to the extant radio environment. Since excessive high power transmissions are also undesirable (as discussed supra), the UE may further consider one or more network inefficiencies caused by high power transmissions, and adjust its behavior accordingly. In one such variant, the UE device calculates an appropriate power level based on multiple considerations and rules which are incorporated within an optimization engine operative to run on the UE (e.g., on the microprocessor thereof). Such optimization engines may incorporate various weighting algorithms, operational rules, cost/benefit analyses, etc. to determine the optimal transmit power in light of multiple variables. For example, a UE may ascribe one or more weights to: battery level, measured RSRP, historical performance, etc. to determine an incremental increase (or decrease) in transmit power.

Referring back to step 214, in some embodiments, the transmit power calculation may be differential in nature. For example, an initial calculation may be based on a determined absolute value of the parameter. Successive calculations can be handled as corrections to the initial calculation (e.g., “deltas”). By minimizing the amount of processing burden required to determine transmit power (such as by use of differential calculations), device implementation complexity can be greatly simplified (and hence allowing the algorithm to be implemented over a much wider population of devices).

Often, the transmit power calculation will be either proportional or inversely proportional to the parameter (or parameter change). For example, the parameters which measure noise or interference of the channel will often be proportionally related to the transmit power (a noisy channel will require proportionately more transmit power, etc.); similarly, parameters which measure quality of the channel will be inversely related to the transmit power (a clear channel will require less transmit power, etc.). Moreover, it is further appreciated that, due to the logarithmic nature of radio transmissions, the calculation may incorporate logarithmic and/or exponential operations; hence, the term “proportional” as used herein is broadly intended to include both direct proportionality and other mathematical relationships such as without limitation the foregoing logarithmic and exponential operations.

It can further be appreciated that the calculation need not be the same over the entire range of operation; in some embodiments, transmit power can be calculated according to a “piecewise” calculation. For example, for a first range of a first parameter, transmit power can be calculated according to a first scheme, whereas for a second range of the first parameter, the transmit power can be calculated according to a second scheme. Such piece-wise approach may be necessitated by e.g., non-linearities in the behavior of certain physical parameters, non-linearities in the effects of transmit power on the underlying bearer infrastructure (e.g., network congestion), and so forth. In some embodiments, different profiles may be used to optimize for different behaviors. Common examples of different profiles include, without limitation: remaining battery-life of the device, likelihood of success, interference minimization, high performance, etc. In some embodiments, the device may accept configurable options to better address certain parties (e.g., customers, manufacturers, or network operators).

Referring again to FIG. 2A, at step 216, the UE transmits the RACH attempt at the power level calculated at step 214. In one exemplary embodiment, an LTE UE performs an access request with an initial RACH attempt. The access request can be for instance a single transmission, or a series of accesses. In common variants, the series of accesses may be set at a fixed level, or alternatively dynamically adjusted (e.g., varying increments to ramp up or down).

For those embodiments which attempt multiple RACH attempts, multiple considerations can arise. For example, the UE may limit retry attempts according to e.g., a number of iterations, a time interval, etc. In some variants, the UE is configured to limit the maximum transmit power according to e.g., battery power considerations, and/or regulatory concerns. It is further appreciated that combinations of iterative limits (e.g., a maximum number of iterations, a minimum number of iterations, etc.) may be used.

Moreover, in some variants, the device may dynamically configure access requests for multiple attempts. For example, in one such variant, the device may dynamically ramp between multiple access requests. The ramping value can be based on current radio environment information, and/or historical information. For instance, the device may use a large value (for ramping subsequent requests) when the radio quality is poor, and a smaller value when the radio quality is good.

Moreover, it is further appreciated that dynamically determined ramping attempts may create significant interference for other devices, potentially causing each device to increase transmission power. In extreme scenarios, a feedback loop could occur and result in sub-optimal network operation. Accordingly, in some embodiments of the invention, the network (or other supervisory entity) may turn off or dynamically alter power ramping behaviors for various subsets of the population of devices, so as to avoid such scenarios. Alternately, the mobile device (e.g., UE) may be equipped with internal functionality to identify the presence of other devices which may be affected by the UE's “intelligent” power ramping techniques as described above, and adjust its behavior accordingly (i.e., so as to mitigate the opportunity for such feedback loops or other deleterious and unwanted side effects to occur). For instance, the UE may be configured with certain patterns or templates of operation (e.g., combinations of parameters such as transmit powers, TAs, MIMO configurations, modulations/codings, etc.) which are known or projected to cause such deleterious effects on other UEs, and logic to avoid these patterns wherever possible, consistent with the goals of providing more better or more efficient connection establishment.

At step 218, after each RACH attempt, the UE waits to determine if the eNB received the access request. In one exemplary embodiment, the UE checks for a connection response (Acquisition Indication (AI)) via a downlink Acquisition Indicator Channel (AICH) which is paired (according to a predefined relationship) to the RACH. If the AI connection response is not received at the designated time, then the RACH has failed. In other technologies, a connection response may have a proper check procedure (e.g., a cyclic redundancy check (CRC), etc.), indicating successful receipt. Yet other approaches for determining receipt/success of an access attempt will be recognized by those of ordinary skill given the present disclosure.

If a response is received at step 218, the connection request was successful, and the initiator device can connect to the eNB. Within the exemplary context of an LTE network, the LTE eNB and LTE UE execute authentication, authorization and resource allocation; thereafter, the UE can transact data with the network. However, if an AICH response is not received at step 218, then the UE may retry the access request (repeating steps 212, 214, and 216). In one exemplary embodiment, before retrying the access request, the UE additionally considers one or more additional conditional requirements before retrying the access request.

For example, the UE can determine if a retry limit or maximum attempt limit has been reached. In some implementations, the UE may enforce minimum or maximum thresholds to prevent erratic behavior. For instance, if the difference in Reference Signal Received Power (RSRP) has not significantly changed beyond a minimum threshold value, then the UE does not need to aggressively ramp transmit power. Similarly, if the measured difference in RSRP has significantly changed, the UE may adjust its behavior in moderation to prevent wild swings in transmission power.

The UE may also be configured to alternate between fixed power ramping schemes, and dynamically determined power ramping schemes. For example, a UE may automatically transmit according to a default fixed scheme (e.g., a legacy “fixed” linear ramping scheme) for a first number of attempts (or until some other criteria is met, such as a prescribed temporal duration), and switch to a dynamically determined power ramping scheme for a second number of attempts (or duration). By controlling the proportion of fixed and dynamically determined power ramping, the device can fine tune the level of “aggression” for establishing a connection to the network. More aggressive schemes increase the transmission power of access request attempts to increase the likelihood of success.

Moreover, in some variants, the behavior of the UE may change with the amount of battery power remaining in the device. For example, a device with low battery power may be configured to ensure a high success rate in establishing connections (to avoid the wasted power associated with failed attempts). Thus, a more aggressive scheme may be applied to more quickly increase transmit power in response to changing received signal quality. Conversely, to reduce network interference with other neighboring devices using the same or similar channels, a less aggressive approach may be applied, especially where battery power is sufficiently high such that extra (failed) attempts do not pose a significant issue for user experience or remaining battery longevity.

Finally, given the increasing levels and type of data available to devices, it may be possible for a location-aware device to identify conditions in which more aggressive connection strategies are beneficial. For example, a device with GPS capabilities may be able to determine if it is being used in a moving car (e.g. by a position vs. time measurement), or in a city with tall buildings or other landscape with high variability of radio channel path metrics. In such scenarios, it is likely that connection conditions will change more rapidly that when compared to use in a slower moving mode (e.g. a person walking) or other less challenging landscapes, respectively, thus the device can aggressively pursue connection establishment by using dynamic power ramping strategies.

### Exemplary Mobile Device—

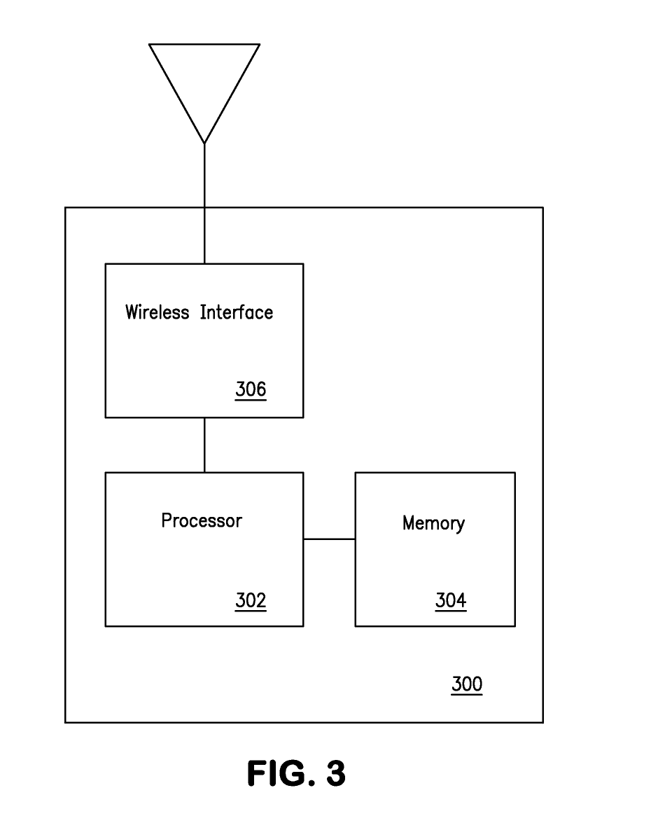

Referring now to FIG. 3, an exemplary user device apparatus 300 configured for improved power ramping is illustrated. While a specific device configuration and layout is shown and discussed, it is recognized that many other configurations may be readily implemented by one of ordinary skill given the present disclosure, the apparatus 300 of FIG. 3 being merely illustrative of the broader principles of the invention.

The processing subsystem 302 includes one or more of central processing units (CPU) or digital processors, such as a microprocessor, digital signal processor, field-programmable gate array, RISC core, a baseband processor, or plurality of processing components mounted on one or more substrates. In some embodiments, one or more of the above-mentioned processors (e.g. the baseband processor) are further configured to implement the power ramping methods or protocols described previously herein.

The processing subsystem is coupled to non-transitory computer-readable storage media such as memory 304, which may include for example SRAM, FLASH, SDRAM, and/or HDD (Hard Disk Drive) components. As used herein, the term “memory” includes any type of integrated circuit or other storage device adapted for storing digital data including, without limitation, ROM. PROM, EEPROM, DRAM, SDRAM, DDR/2 SDRAM, EDO/FPMS, RLDRAM, SRAM, “flash” memory (e.g., NAND/NOR), and PSRAM. The processing subsystem may also include additional co-processors, such as a dedicated graphics accelerator, network processor (NP), or audio/video processor. As shown, the apparatus 300 (including the processing subsystem 302) is comprised of discrete components; however, it is understood that in some embodiments they may be consolidated or fashioned in a SoC (system-on-chip) or other configuration which consolidates these components.

In one implementation, the non-transitory computer-readable storage media includes instructions (e.g., in the form of a computer program) which, when executed by the processing subsystem, implement dynamic power control and connection establishment techniques, such as for instance one or more power calculations during one or more access requests based on e.g., one or more measured received reference signal characteristics.

The apparatus 300 further includes one or more wireless interfaces 306 which are configured to transmit to, and receive transmissions from, a wireless network infrastructure such as a base station. In some embodiments, the wireless interfaces may include (or be configured to operate in conjunction with) a baseband processor, such as that discussed within the processing subsystem 302, to implement the power control features discussed herein. For example, the wireless interface may include a Long Term Evolution (LTE) transceiver, comprising one or more antennas (e.g., in a MIMO configuration) and/or a baseband processor.

In one exemplary embodiment, the wireless interface 306 (in conjunction with the processor subsystem 302) is also configured to measure signal parameters (e.g., the signal strength or change in signal strength) of one or more received signals. For instance, the signal strength may be periodically or intermittently measured (e.g., based on interspersed Reference Signals (RS) such as those employed within LTE networks). Alternately, the signal strength can be continuously measured (e.g., based on a continuous broadcast of a so-called pilot signal, such as those employed within CDMA 1X networks). As previously noted, common metrics for signal strength include for example: Received Signal Strength Index (RSSI), Signal to Noise Ratio (SNR), Signal to Interference plus Noise Ratio (SINR), Reference Signal Received Power (RSRP), etc., any of which can be evaluated using the transceiver 306 and processor subsystem 302 of the apparatus 300.

In other embodiments, the wireless interface 306 is configured to measure the quality (or change in quality) of one or more signals. Common measurements of quality include for example, a Bit Error Rate (BER), a Block Error Rate (BLER), a Packet Error Rate (PER), etc. In some variants, the BER is specific to a subset of the signals e.g., Reference Signal Received Quality (RSRQ), etc. as previously discussed.

More generally, various embodiments of the apparatus 300 utilize the transceiver 306 and processing subsystem 302 to determine and/or evaluate a change in one or more radio channel parameters, such as channel quality, network congestion, device requirements, data requirements, etc., or combinations or derivations of the foregoing.

The wireless interface 306 is further configured to transmit one or more access attempts according to a transmit power level which is dynamically determined by the processing subsystem 302. For example, in one exemplary embodiment, the wireless interface is configured to perform a Random Access Channel (RACH) attempt at the dynamically determined transmit power level. An exemplary LTE UE performs RACH attempts and re-attempts according to a transmission power based at least in part on the RSRP.

The non-transitory computer-readable medium 304 may further include instructions which, when executed by the processing subsystem 302, control access attempt operation based on one or more of a number of considerations including, without limitation, a number of access attempts or iterations, a time interval expended on attempting to establish a connection, etc. In some variants, these considerations may also include power considerations (e.g., the effects, regulatory concerns, and/or historical information, etc. For example, the device may use a large value (for ramping subsequent requests) when the radio quality is poor, and a smaller value when the radio quality is good.

### Exemplary Base Station Device—

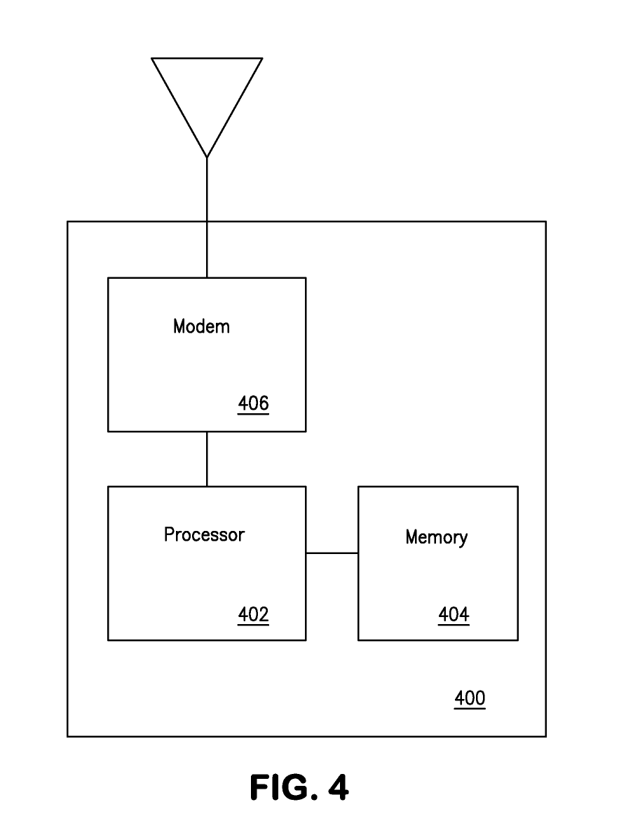

Referring now to FIG. 4, an exemplary network (e.g., base station) apparatus 400 supporting improved power ramping (such as e.g., during a random access request) for a mobile device is illustrated. As used herein, the term “base station” includes, but is not limited to macrocells, microcells, femtocells, picocells, wireless access points, or any combinations of the foregoing. While a specific device configuration and layout is shown and discussed, it is recognized that many other configurations may be readily implemented by one of ordinary skill given the present disclosure, the apparatus 400 of FIG. 4 being merely illustrative of the broader principles of the invention.

The processing subsystem 402 includes one or more of central processing units (CPU) or digital processors, such as a microprocessor, digital signal processor, field-programmable gate array, RISC core, or plurality of processing components mounted on one or more substrates. The processing subsystem is coupled to non-transitory computer-readable storage media such as memory 404, which may include for example SRAM, FLASH, SDRAM, and/or HDD (Hard Disk Drive) components. The processing subsystem may also include additional co-processors. As discussed above with respect to FIG. 3, while the shown processing subsystem 402 includes discrete components, it is understood that in some embodiments they may be consolidated or fashioned in a SoC (system-on-chip) configuration.

The apparatus 400 further includes one or more wireless interfaces 406 which are configured to receive/send transmissions from/to mobile devices (including connection request responses). In one exemplary embodiment, the wireless interface includes a Long Term Evolution (LTE) transceiver, comprising one or more antennas and a baseband processor.

### Exemplary Operation—

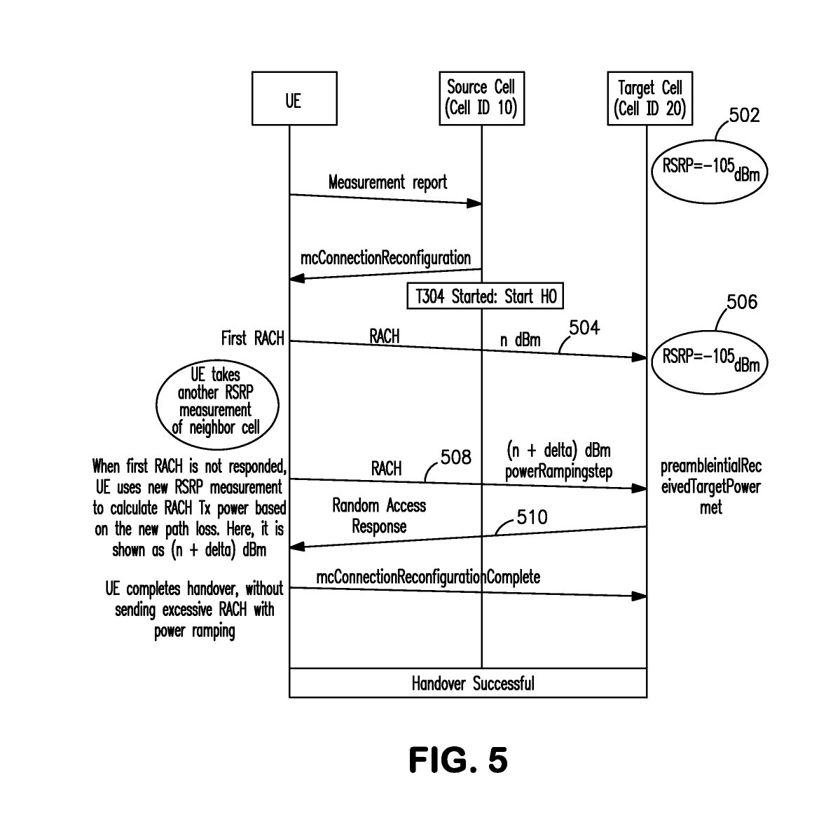

Referring now to FIG. 5, a ladder diagram of an exemplary power control (e.g., LTE RACH) process is shown to further illustrate various aspects of the invention. As shown, the UE has an ongoing connection to the source cell (cell ID 10), and periodically measures neighboring cells; the measurement reports are provided to the source cell. Based on the measurement reports, the source cell instructs the UE to perform a handover to the target eNodeB (eNB).

In this exemplary scenario, the UE measures an RSRP (via the apparatus previously discussed with respect to FIG. 3) of −105 dBm for the target eNB (cell ID 20, step 502). Accordingly, the initial RACH attempts are transmitted at n dBm, where is n is based on a function of the RSRP of −105 dBm (step 504).

Unfortunately, as shown, by the time the first RACH attempt is performed, the radio environment has already experienced a significant drop in quality (in this scenario, the measured RSRP has fallen to −115 dBm), and thus the first RACH attempt fails. As discussed supra, the rapid changes to the radio environment may be caused by any number of factors such as comparatively high rate of movement of the UE, challenging structural/geographic environments, etc.

Accordingly, the UE re-attempts a subsequent RACH attempt; first, the UE measures a new RSRP of −115 dBm (step 506). Since the channel has significantly degraded (i.e., the measured RSRP has fallen significantly), the UE determines a new power level for the RACH request based on the higher path loss. The UE compensates for the 10 dB drop in RSRP with an increase of Δ dB in its RACH request (where Δ is based on a function of 10 dB). Thus, at step 508, the second RACH request is transmitted at a power level of (n+Δ) dBm. In one exemplary embodiment, the value of Δ dB is directly proportional to the change in RSRP (i.e., a drop of 10 dB is directly matched to an adjustment of 10 dB in transmit power). As shown, the second RACH request receives a response from the target eNB, and the handover process successfully completes (step 510). While not shown in FIG. 5, if the second RACH request is not received, the process will repeat until successful (or until a maximum number of iterations is reached, a maximum transmit power is reached, etc.).

In a second similar example, one exemplary implementation of dynamic power ramping is discussed in combination with fixed power ramping. In this scenario, a “default” power ramp of +2 dB per step is set. In one exemplary embodiment, the default power ramp is provided by the eNB within a so-called “system information block” (SIB). Specifically, existing networks provide a powerRampingStep parameter within SIB2. For example, if the radio environment is relatively stable, and a RACH attempt fails, the UE will increase its transmit power by +2 dB. As in the foregoing example, an RSRP of −105 dBm is measured for the target eNB. The UE is instructed to perform a handover, and transmits an initial RACH request at n dBm, where is n is based on a function of the RSRP of −105 dBm. In some alternate embodiments, a device may be pre-coded with a default power ramp.

A response from the target eNB to the first RACH request is not received. However, the UE measures a new RSRP of −106 dBm which is not a significant or precipitous change from the 105 dBm value. The subsequent RACH attempt is increased by the fixed 2 dB increment; i.e., the re-attempted RACH request is transmitted at a power level of (n+2) dBm. The second RACH also receives no response, and a sudden (larger) drop in the RSRP from the target eNB occurs.

During the second retry (the third RACH attempt) the UE measures a RSRP of −115 dBm. Since the channel has significantly degraded, the UE cannot rely on the default power level for the third RACH request (i.e. (n+2+2) dBm). Instead, the UE accounts for the 9 dB drop in RSRP with an increase of Δ dB in its RACH request (where Δ is determined based on a drop of 9 dB). For example, the UE may increase its transmit power by a full 11 dB (i.e., 9 dB+2 dB); in other schemes, the transmit power may be a fraction thereof (e.g., to prevent sudden spikes in transmit power). The third RACH request receives a response from the target eNB, and the handover process successfully completes.

The foregoing example is based on differences in measured RSRP, rather than absolute RSRP. However, it is appreciated that in other variants, the UE may use absolute values; i.e., rather than calculating Δ for the each RACH request, the UE calculates m (where m is based on the absolute received RSRP).

In still other implementations, the UE may utilize less aggressive schemes that alternate between default RACH request power levels and dynamically determined RACH request power levels. Such flexibility in implementation can be used to maximize, inter alia, UE design, eNB design, UE batter life (or battery life remaining), user preferences, network operator preferences, and/or needs related to applications stored on or running on the UE or eNB. For example, a less aggressive scheme may be used for a UE with 90% of battery life left and no active data streams, because a failed handover may be less disruptive to such a device. Conversely, a more aggressive scheme may be used for a device with 10% of battery life left and several applications requesting data access, because a failed handover would constitute a significant disruption.

Moreover, as alluded to above, the UE may dynamically adjust its “aggression” based on network or other operational conditions. Primary detriments to the prior art ramping approach include: (i) latency (i.e., by utilizing a programmatic ramp profile in all cases, many operational connection scenarios will take longer than otherwise needed by an “intelligent” power control scheme such as that of the present invention), and (ii) somewhat indiscriminant use of high transmit power levels which may disrupt operations of other devices using the CDMA- or OFDM-based network. Hence, in some variant of the present invention, if few or no other UEs or competing devices are detected at the time the UE initially measures the radio environment (as determined by e.g., the initiating UE measuring or sending the radio environment, or being provided information such as by the network), it may selectively violate transmit power control limitations under (ii) above as a trade for reduced latency under (i), especially where remaining battery life is limited, and/or one or more in-progress streams exist. In effect, one (presumed) very high transmit power RACH attempt may actually consume less electrical power within the UE than multiple lower-power ramped attempts. Accordingly, various implementations of the invention contemplate sensing the radio environment (e.g., via RSRP) initially, and then if no other deleterious consequences would result, setting the initial RACH transmit power very high so as to in effect assure a response irrespective of whether the radio environment is rapidly degrading/changing. In still other variants, the eNB may be capable of providing congestion information to its client devices. For example, in one embodiment, the eNB may provide congestion information via one or more system information messages.

It will be recognized that while certain aspects of the invention are described in terms of a specific sequence of steps of a method, these descriptions are only illustrative of the broader methods of the invention, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the invention disclosed and claimed herein.

While the above detailed description has shown, described, and pointed out novel features of the invention as applied to various embodiments, it will be understood that various omissions, substitutions, and changes in the form and details of the device or process illustrated may be made by those skilled in the art without departing from the invention. The foregoing description is of the best mode presently contemplated of carrying out the invention. This description is in no way meant to be limiting, but rather should be taken as illustrative of the general principles of the invention. The scope of the invention should be determined with reference to the claims.

What is claimed is:

1. A method for establishing a connection to a target apparatus with an initiating device, the method comprising:
determining a parameter at a first time, where the determined parameter is related to a power associated with signal transmitted by the target apparatus;
transmitting an access attempt at a first power level, the first power level based at least in part on the determined parameter; and
when a response to the access attempt is not received:
updating the parameter at a second time; and
transmitting a second access attempt at a second power level, the second power level based at least in part on the updated parameter.

2. The method of claim 1, further comprising setting the second power level at the first power level increased by a fixed increment when the updated parameter is not substantially different from the parameter determined at the first time.

3. The method of claim 1, wherein the second power level is dynamically determined based on the updated parameter.

4. The method of claim 1, further comprising:
when the updated parameter is not substantially different from the parameter determined at the first time, setting the second power level equal to the first power level plus a fixed increment; and
otherwise dynamically determining the second power level based on the updated parameter.

5. The method of claim 1, wherein the second power level is based on a difference between the parameter determined at the first time and the updated parameter.

6. The method of claim 1, further comprising repeating subsequent access attempts until a predetermined limit is reached.

7. The method of claim 6, wherein the predetermined limit comprises a time limit.

8. The method of claim 6, wherein the predetermined limit comprises a maximum number of retries.

9. The method of claim 1, wherein:
the initiating device comprises a long term evolution (LTE) compliant user equipment (UE); and
the target apparatus comprises an LTE-compliant evolved NodeB (eNB).

10. The method of claim 9, wherein the received signal comprises a reference signal (RS), and the parameter comprises a reference signal received power (RSRP).

11. The method of 9, wherein the access attempt comprises a random access channel (RACH) request during an LTE handover operation.

12. A mobile device configured to establish a connection to a target apparatus in a wireless network, the device comprising:
a wireless transceiver, the transceiver configured to:
receive a reference signal;
transmit one or more request signals at one or more respective power levels; and
receive a response to the transmitted one or more request signals;
a processor; and
a non-transitory computer-readable storage comprising a plurality of instructions, which when executed by the processor:
monitor a value related to a signal strength of the reference signal at one or more times; and
determine the respective power levels for the one or more request signals, at least one of the respective power levels based at least in part on the monitored value.

13. The device of claim 12, wherein the determination of at least one of the respective power levels is based at least in part on a change in the signal strength of the reference signal.

14. The device of claim 12, wherein:
the mobile device comprises a long term evolution (LTE) compliant user equipment (UE); and
the target apparatus comprises an LTE-compliant evolved NodeB (eNB).

15. The device of claim 14, wherein the value comprises a reference signal received power (RSRP).

16. The device of claim 14, wherein the one or more request signals each comprise a random access channel (RACH) request.

17. A method for establishing a connection to a target apparatus with an initiating device, the method comprising:
determining a first parameter related to a received signal power associated with a transmission of the target apparatus;
determining a second parameter related to a likelihood of success for the connection; and
transmitting an access attempt at a first power level, the first power level based at least in part on the first and second parameters.

18. The method of claim 17, wherein:
the mobile device comprises a long term evolution (LTE) compliant user equipment (UE); and
the target device comprises an LTE-compliant evolved NodeB (eNB).

19. The method of claim 18, wherein the first parameter is determined from a received power associated with a reference signal.

20. The method of claim 19, wherein the initiating device comprises a mobile device having a battery, and the second parameter is determined based at least in part on a power consumption consideration of the mobile device.

21. The method of claim 20, wherein the second parameter is further determined based at least in part on a determination of the existence of one or more data transmission or reception processes in progress on the mobile device at a time of the determining of the second parameter.

22. A mobile device configured to selectively adjust transmit power based at least on its radio environment, the device comprising:
a processor;
a radio transceiver in signal communication with the processor; and
computerized logic in communication with the transceiver, the logic configured to:
utilize the transceiver to sense at least one aspect of the radio environment;
select a transmit power for a transmission to be sent to a target device, the selection being based at least in part on the sensed at least one aspect;
cause the transmission to be transmitted from the transceiver;
monitor for an indication of receipt of the transmission by the target device; and
based on an absence of the indication, determine a transmit power for a second transmission, the determined transmit power for the second transmission being selected to maximize a likelihood that the second transmission will be received by the target device.

23. The mobile device of claim 22, wherein the at least one aspect of the radio environment comprises a parameter related to a signal strength of a signal that is transmitted from the target device on a routine basis.

24. The mobile device of claim 23, wherein the signal that is transmitted from the target device on a routine basis comprises a reference signal (RS) of an LTE-compliant base station.

25. The mobile device of claim 23, wherein the signal that is transmitted from the target device on a routine basis comprises a pilot signal (RS) of a code divided multiple access (CDMA) network.
